(19) United States
(12) Patent Application Publication
(10) Pub. No.: US 2022/0363261 A1
(43) Pub. Date: Nov. 17, 2022

(54) SYSTEM AND METHOD FOR ACOUSTIC DETECTION OF EMERGENCY SIRENS

(71) Applicant: Cerence Operating Company, Burlington, MA (US)

(72) Inventors: Markus Buck, Ulm (DE); Julien Premont, Ulm (DE); Friedrich Faubel, Ulm (DE)

(21) Appl. No.: 17/790,006

(22) PCT Filed: Jan. 5, 2021
(86) PCT No.: PCT/US2021/012159

§ 371 Date: Jun. 29, 2022

Related U.S. Application Data
(63) Continuation-in-part of application No. 16/516,786, filed on Jul. 19, 2019, now Pat. No. 10,996,327.
(60) Provisional application No. 62/962,278, filed on Jan. 17, 2020.
(60) Provisional application No. 62/957,290, filed on Jan. 5, 2020.
(60) Provisional application No. 62/701,169, filed on Jul. 20, 2018.

(51) Int. Cl. B60W 40/04; G06K 9/00; G08G 1/0965; B60W 50/14; B60W 60/00; B60W 30/16; B60W 30/18; G01C 21/34

(52) U.S. Cl. CPC B60W 40/04; G06K 9/0055; G08G 1/0965; B60W 50/14; B60W 60/0053; B60W 30/16; B60W 30/18009; G01C 21/3461; B60W 60/0015; G01C 21/3415; B60W 2554/402

(57) ABSTRACT

A method detects presence of a multi-tone siren type in an acoustic signal. The multi-tone siren type is associated with one or more siren patterns, where each siren pattern includes a number of time patterns at corresponding frequencies. The method includes processing a number of frequency components of a frequency domain representation of the acoustic signal over time to determine a corresponding plurality of values. That processing includes determining, for each frequency component, a value characterizing a presence of a time pattern associated with at least one siren pattern. The method also includes processing the values according to the siren patterns to determine a detection result indicating whether the multi-tone siren type is present in the acoustic signal.

### CROSS-REFERENCE TO RELATED APPLICATIONS

This application claims priority to U.S. Provisional Application No. 62/957,290, filed on Jan. 5, 2020 and U.S. Provisional Application No. 62/962,278, filed on Jan. 17, 2020, the contents of which are hereby incorporated by reference in their entirety.

### BACKGROUND

### 1. Field of the Disclosure

The present disclosure is directed to a system and method for detecting multi-tone sirens, and particularly for detecting multi-tone sirens despite environmental noises that may be present.

### 2. Description of Related Art

Automated vehicles that are capable of sensing their environment and operating with little to no human effort are being rapidly developed and deployed. Automated vehicles include autonomous vehicles, semi-autonomous vehicles and vehicles with automated safety systems. These vehicles provide full or partly automated control features that keep the vehicle within its lane, perform a lane change, regulate speed and engage the vehicle brakes, for example.

A well-known classification system is promulgated by The Society of Automotive Engineers (SAE International) and classifies vehicles according to six increasing levels of vehicle automation, from “Level 0” to “Level 5”. These levels feature, in increasing order, warning systems but no automation, driver assistance, partial automation, conditional automation, high automation and full automation. Level 0 vehicles have automated warning systems, but the driver has full control. Level 5 vehicles require no human intervention. The term “automated vehicle” as used herein includes Level 0 to Level 5 autonomous and semi-autonomous vehicles.

In most cities and countries, laws require that vehicles pull over and yield to approaching emergency vehicles. Emergency vehicles utilize multi-tone sirens that cycle through a sequence of tones having a predefined duration. Recognition of approaching emergency vehicles is critical to public safety in general and especially in systems for automated vehicles.

Present siren detection methods lack robustness in real world operating conditions because of environmental noise. As used herein, environmental noises include sounds produced by vehicles and vehicular traffic, speech, music, and the like.

### SUMMARY

In a general aspect, a method detects presence of a multi-tone siren type in an acoustic signal. The multi-tone siren type is associated with one or more siren patterns, where each siren pattern includes a number of time patterns at corresponding frequencies. The method includes processing a number of frequency components of a frequency domain representation of the acoustic signal over time to determine a corresponding plurality of values. That processing includes determining, for each frequency component, a value characterizing a presence of a time pattern associated with at least one siren pattern. The method also includes processing the values according to the siren patterns to determine a detection result indicating whether the multi-tone siren type is present in the acoustic signal.

Aspects may include one or more of the following features.

The method may include selecting the siren patterns based at least in part on a siren type corresponding to a geographic location associated with the acoustic signal. The siren patterns may include a group of siren patterns representing a variation in time or frequency of the multi-tone siren type. The variation may be due to one or more of a doppler shift or a variation within a tolerance associated with the multi-tone siren type. Each time pattern associated with a siren pattern may include a pulsatile sequence at a corresponding frequency.

The method may include causing presentation of an indicator to an operator of a vehicle based on the detection result, the indicator alerting the operator to the presence of the multi-tone siren type. The indicator may include a visual indicator. The indicator may include an audio indicator. The indicator may include an indication of the type of multi-tone siren detected.

The method may include causing a change in an operating mode of a vehicle based on the detection results. The change in the operation mode of the vehicle may include a change from an autonomous operating mode to a manual operating mode. The method may include causing an audible presentation of instructions to a driver of the vehicle, the audible presentation of instructions including instructions for the driver to engage the vehicle controls for manual operation. The method may include causing a vehicle to reduce a speed of travel based on the detection result.

The method may include causing a vehicle to perform a maneuver based on the detection result. The maneuver may include an evasive maneuver. The maneuver may include moving the vehicle to a shoulder of a road. The maneuver may include causing the vehicle to change a distance between itself and nearby vehicles. Changing the distance may include increasing the distance.

The method may include causing an audible presentation of instructions to a driver of the vehicle, the audible presentation of instructions including instructions for to modify their driving behavior. The instructions may instruct the driver to drive less aggressively or more safely.

The method may include causing a navigation system to plan a different route based on the detection result. The method may include causing a vehicle associated with the navigation system to autonomously follow the different route. The different route may circumvent a location of the emergency vehicle. The different route may be provided to a driver of a vehicle for navigating around a location of an emergency vehicle. The detection result may be indicative of an event. The event may include a car accident.

In another general aspect, a system is configured for detecting presence of a multi-tone siren type in an acoustic signal. The multi-tone siren type is associated with one or more siren patterns, each siren pattern including a plurality of time patterns at corresponding frequencies. The system includes an acoustic signal processing module configured to process a number of frequency components of a frequency domain representation of the acoustic signal over time to determine a corresponding number of values. The processing includes determining, for each frequency component a value characterizing a presence of a time pattern associated with at least one siren pattern. The system also includes a multi-tone siren type detection module configured to process the values according to the siren patterns to determine a detection result indicating whether the multi-tone siren type is present in the acoustic signal.

The present disclosure provides a system and method for detecting a multitone siren by accounting for a doppler shift attributable to a relative speed between an emergency vehicle and an automated vehicle.

The present disclosure provides such a system and method that uses an explicit model of the multi-tone siren signal, which model describes the siren as a sequence of tones that are specified by their fundamental frequency and duration.

The present disclosure further provides such a system and method that factors and/or models the change of the tones' fundamental frequencies and durations due to the doppler shift.

The present disclosure still further provides such a system and method that uses integral signal representations to efficiently detect tone duration patterns.

The present disclosure still further provides such a system and method that considers the effect on upper harmonics.

The present disclosure still yet further provides such a system and method that detects tones over their entire duration period so that unwanted perturbation by interfering tonal signals such as speech and music is minimized.

The system and method of the present disclosure can advantageously detect the siren signals at very low signal-to-noise ratios (SNR) and notwithstanding whether the siren signal is overlaid by tonal signals, such as speech or music.

### BRIEF DESCRIPTION OF THE FIGURES

The accompanying drawings illustrate aspects of the present disclosure, and together with the general description given above and the detailed description given below, explain the principles of the present disclosure. As shown throughout the drawings, like reference numerals designate like or corresponding parts.

FIG. 1 shows an exemplary environment for the system and method of the present disclosure.

FIG. 2 shows an exemplary embodiment of the system according to the present disclosure.

FIG. 3 shows a fundamental frequency of a multi-tone siren over time.

FIG. 4 show the fundamental frequency of FIG. 3 and upper harmonics at integer multiples of the fundamental frequency.

FIG. 5 is a logic diagram of an example method of the present disclosure.

FIG. 6 shows an example duration pattern for a single tone pattern.

FIG. 7 shows an example duration pattern for a two-tone pattern.

FIG. 8 is a logic diagram of an example algorithm for the detection of siren segments.

### DETAILED DESCRIPTION

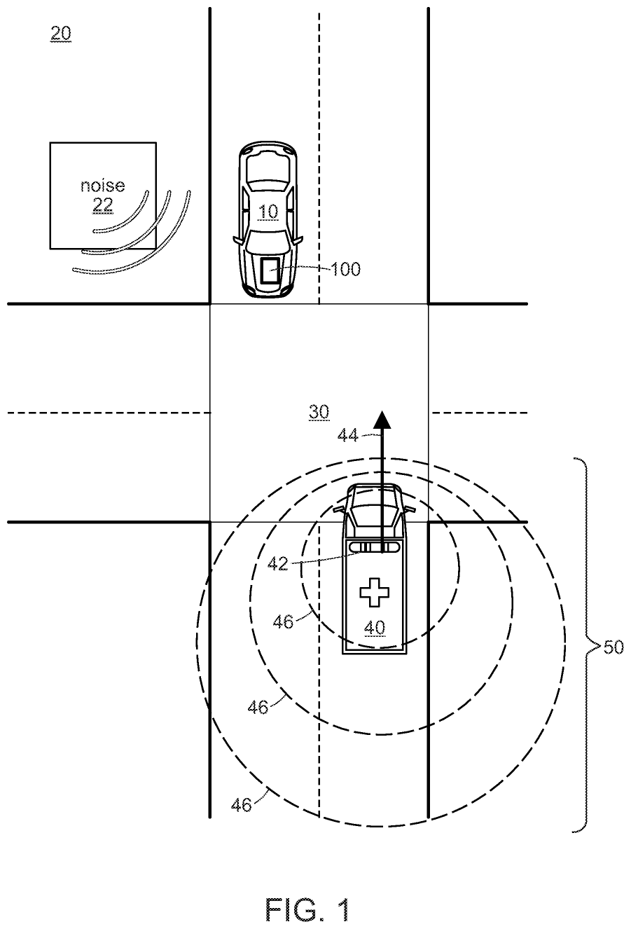

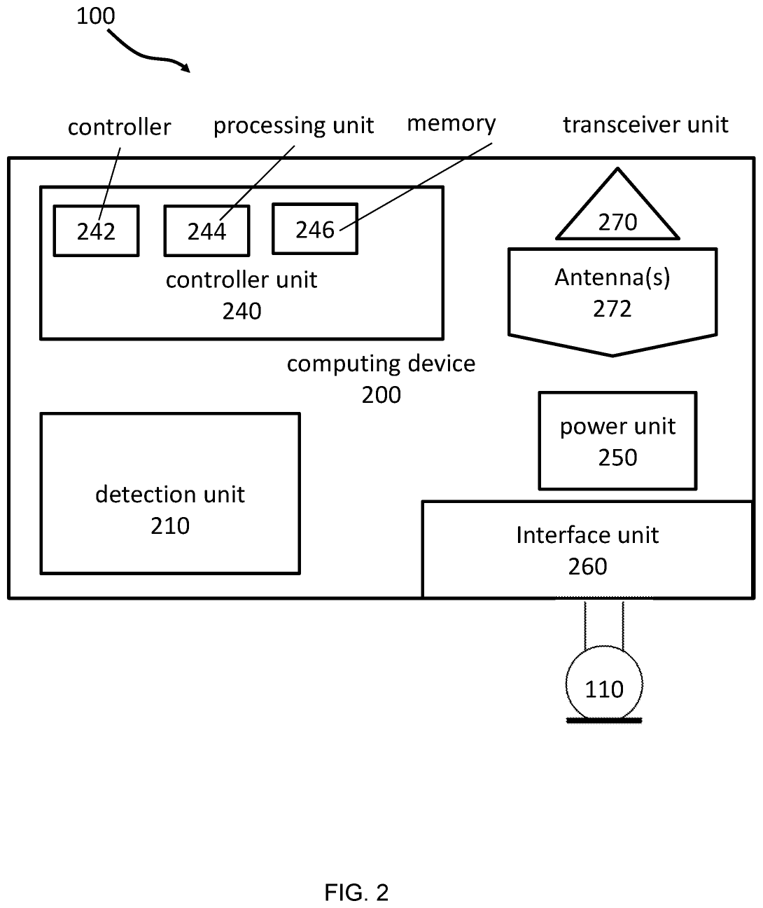

Referring to the drawings and, in particular to FIGS. 1 and 2, a system for acoustic detection of emergency sirens is generally represented by reference numeral 100, hereinafter “system 100”. As shown in FIG. 2, system 100 utilizes a microphone 110 and computing device 200 to acoustically detect an active emergency siren, e.g., siren 42, in an example environment 20 shown in FIG. 1.

Referring again to FIG. 1, an automated vehicle 10 having system 100 is shown operating in environment 20 on an example roadway system, e.g., roads 30. An emergency vehicle 40 having siren 42 is also operating on roads 30. Emergency vehicle 40 is traveling in a direction 44 as indicated by an arrow.

Siren 42 produces sound waves 46. In example embodiments, siren 42 is a multi-tone siren. As used herein, a “multi-tone siren” is a loud noise-making device that generates two or more alternating tones such as alternating “hi-lo” signals. Unless otherwise specified in this disclosure, a sound is a vibration that typically propagates as an audible wave of pressure, through a transmission medium. A tone is sound at one specific frequency.

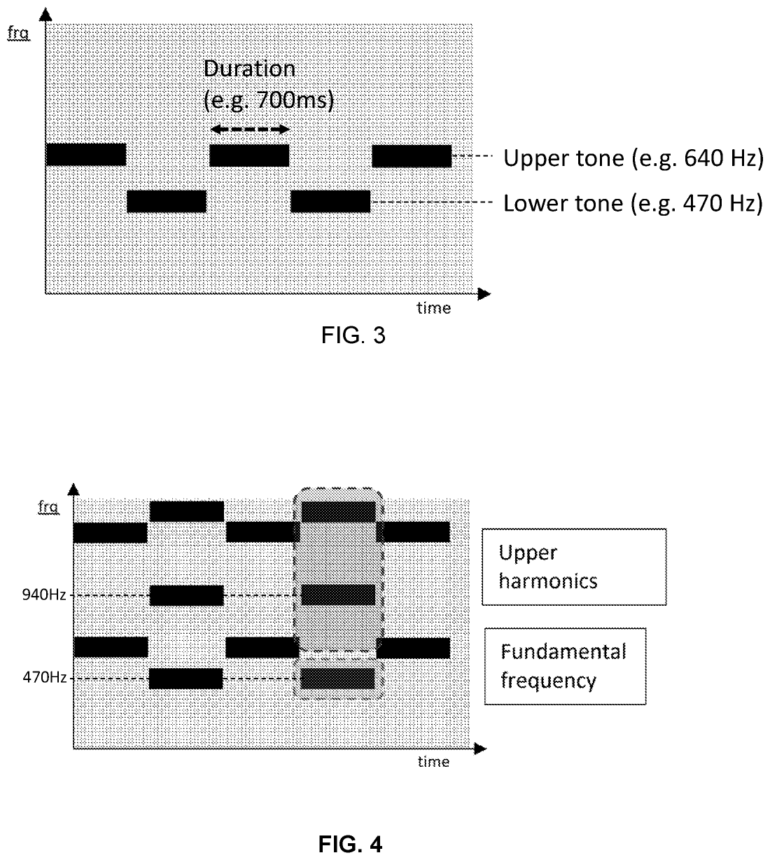

FIG. 3 shows an example fundamental frequency of a multi-tone siren, such as siren 42, over time. Siren 42 produces a repeating pattern or sequence of tones, which have different fundamental frequencies and durations. The grid indicates time/frequency bins.

FIG. 4 shows an example fundamental frequency and upper harmonics at integer multiples of the fundamental frequency. The grid indicates time/frequency bins.

Although it can be seen that the time/frequency pattern of a siren signal is clearly defined, in real operating conditions there is significant variability.

Referring back to FIG. 1, an example of such variability is shown. Specifically, sound produced by siren 42 is affected by the doppler effect, which is generally referenced by numeral 50. The doppler effect is a change in frequency or wavelength of sound waves 46 in relation to automated vehicle 10 when there is relative movement between the automated vehicle and the source of the sound waves. In this example, emergency vehicle 40, and thus siren 42, is moving in direction 44. Stated another way, a doppler shift occurs because of the relative speed difference between automated vehicle 10 and approaching emergency vehicle 40 emitting sound from siren 42.

For example, if automated vehicle 10 drives at a velocity of v1=150 km/h and emergency vehicle 40 drives at a velocity of v2=50 km/h, there is a speed difference of v1−v2=100 km/h, which needs to be added to the speed of sound. Hence, the speed of sound changes from c=1235 km/h to c+v1−v2=1335 km/h, which corresponds to a factor of 1335/1235=1.081. This 8% increase in the speed of sound changes the duration of tones by a factor of 1/1.081=0.925 (time stretching factor) and it increases the frequency of tones by 8%, i.e. a 1000 Hz tone becomes a 1080 Hz tone, a 3000 Hz tone becomes a 3240 Hz tone, . . . etc.

In general, if automated vehicle 10 approaches emergency vehicle 40 with a relative speed Δv, the time stretching factor α is defined as:

α=tsf(Δv)=c/(c+Δv)

where c denotes the speed of sound in km/h. The duration of all tones of the siren pattern needs to be multiplied by this value. The change in frequency due to the Doppler shift, by which change each tone frequency is to be multiplied by, is:

1/α=(c+Δv)/c

Note that Δv becomes negative, if the automated vehicle 10 is driving away from emergency vehicle 40. The time stretching factor α will become bigger than 1 in this case and the siren tone frequencies will decrease, as 1/α is smaller than 1.

Noises 22 also exist within environment 20. Noises 22 are environmental noises that include sounds produced by vehicles and vehicular traffic, speech, music, and the like. Noises 22 are generally dynamic with respect to one or more of pitch, intensity, and quality.

Referring to FIG. 2, example components of system 100 will now be discussed.

System 100 includes the following exemplary components that are electrically and/or communicatively connected: a microphone 110 and a computing device 200.

Microphone 110 is a transducer that converts sound into an electrical signal. Typically, a microphone utilizes a diaphragm that converts sound to mechanical motion that is in turn converted to an electrical signal. Several types of microphones exist that use different techniques to convert, for example, air pressure variations of a sound wave into an electrical signal. Nonlimiting examples include: dynamic microphones that use a coil of wire suspended in a magnetic field; condenser microphones that use a vibrating diaphragm as a capacitor plate; and piezoelectric microphones that use a crystal of made of piezoelectric material. A microphone according to the present disclosure can also include a radio transmitter and receiver for wireless applications.

Microphone 110 can be directional microphones (e.g. cardioid microphones) so that focus on a direct is emphasized or an omni-directional microphone. Microphone 110 can be one or more microphones or microphone arrays.

Computing device 200 can include the following: a detection unit 210; a control unit 240, which can be configured to include a controller 242, a processing unit 244 and/or a non-transitory memory 246; a power source 250 (e.g., battery or AC-DC converter); an interface unit 260, which can be configured as an interface for external power connection and/or external data connection such as with microphone 110; a transceiver unit 270 for wireless communication; and antenna(s) 272. The components of computing device 200 can be implemented in a distributed manner.

Detection unit 210 performs the multi-tone siren detection in example embodiments discussed below.

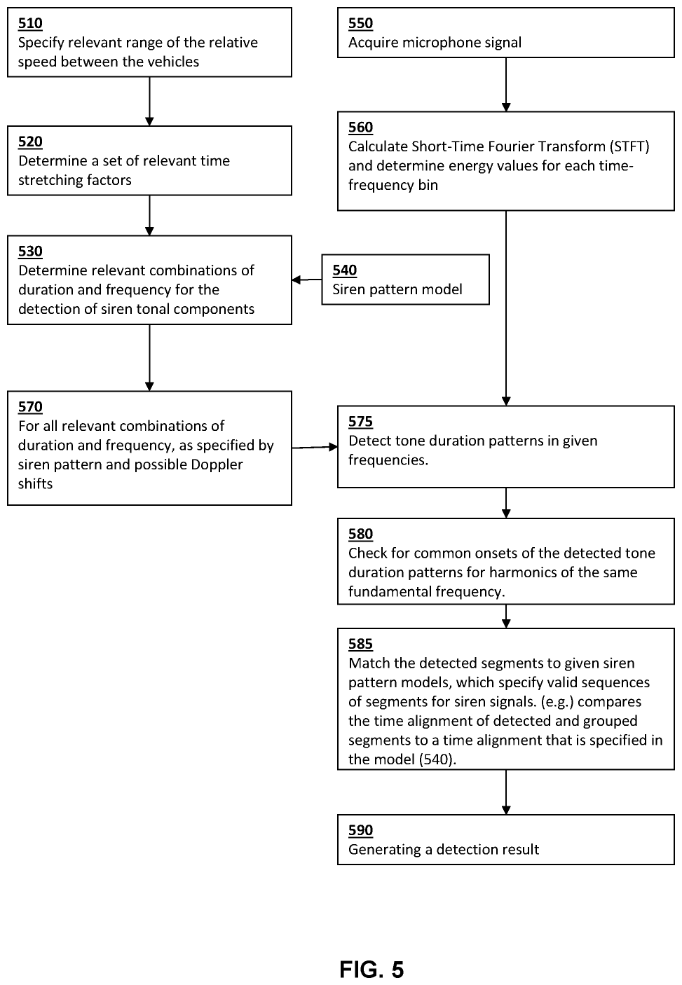

FIG. 5 shows exemplary logic 500 for detection unit 210. Because the Doppler shift, and hence the time stretching factor a, are not known in advance, the detection of duration and frequency translated siren patterns for a set of relevant doppler shift are considered. Logic 500 determines a stretching factor a and applies a siren pattern model for the siren pattern. Based on the time stretching factor a, the duration is multiplied by a while the frequency is multiplied by 1/α.

At step 510 a relevant range of the relative speed between vehicles is specified, e.g. a set of speeds such as {137 km/h, 65 km/h, 0 km/h, −59 km/h, −112 km/h} is considered, possibly with a higher resolution.

At step 520, the doppler effect is considered by determining a set or relevant time stretching factors, e.g. {0.9, 0.95, 1.0, 1.05, 1.1}, which has been derived from the above set of relevant relative speeds according to tsf(Δv), as specified before.

At step 530, relevant combinations of duration and frequency for the detection of siren tonal components are determined and siren pattern model 540 is applied. As used here, “relevant combinations” means that durations specified in the siren pattern model are translated through multiplication by all applicable time stretching factors tsf(Δv). Frequencies specified in the siren pattern model are translated through multiplication by 1/tsf(Δv) for all applicable time stretching factors tsf(Δv).

Advantageously, using an explicit model 540 yields a robust result. For example, an explicit model allows for a distant siren signal to be detected in loud driving noise. An explicit model allows for better discrimination of the siren signal from local signals in the car, such as media playback from smart phones and tablets or cell phone ring tones.

At step 550, microphone 110 acquires a signal from siren 42.

It is noted that step 550 can occur prior to step 510. Steps 510, 520, and 530 can be performed independent of steps 550 and 560. Likewise, steps 550 and 560 can be performed independent of steps 510, 520, and 530.

At step 560, a time-frequency representation of the microphone input signal is obtained by applying, in real time, a time frequency analysis. In this example, short-Time Fourier Transform (STFT) calculations are performed and energy values for each time-frequency bin are determined by detection unit 210.

At step 570, for all relevant combinations of duration and frequency, as determined in step 530, the following steps are iteratively performed: steps 575, 580, 585 and 595.

At step 575, detection unit 210 detects tone duration patterns for each given frequency.

At step 580, detection unit 210 checks for common onsets of the detected tone duration patterns for harmonics of the same fundamental frequency to generate detected segments.

At step 585, detection unit 210 matches the detected segments to given siren pattern models, which specify valid sequences of segments for siren signals.

Finally, at step 590, detection unit 210 generates a detection result.

The detection result can be used as input in automated safety systems of automated vehicle 10.

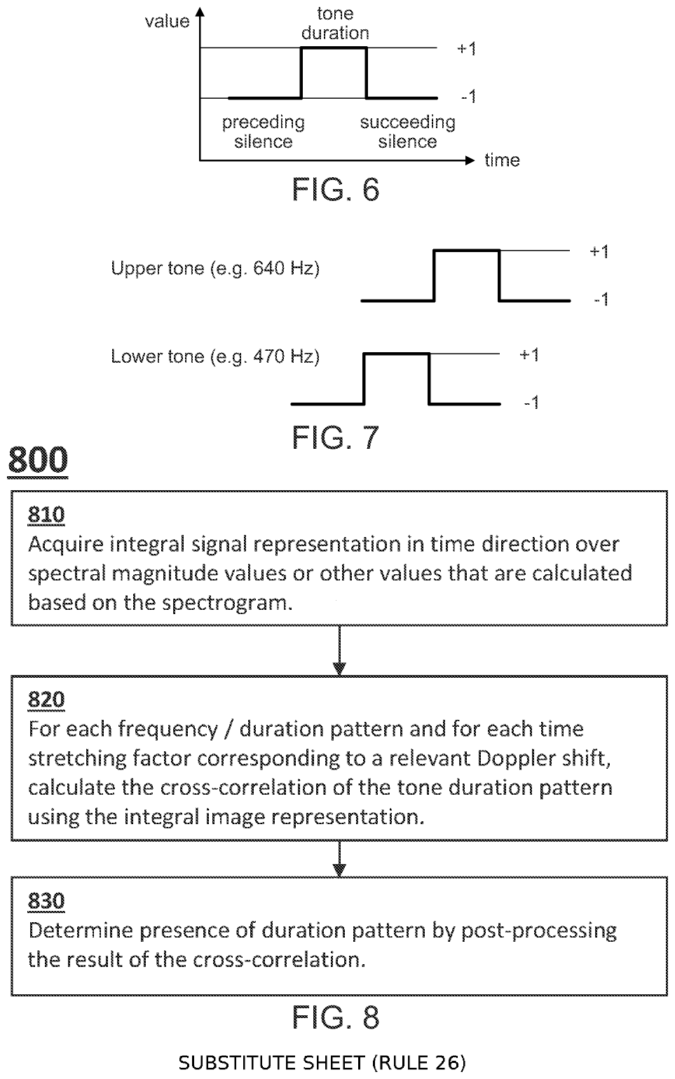

FIG. 6 is an example of a typical tone duration pattern, as used in step 575. The duration pattern specifies the tone activity in time direction. For this example, the duration pattern can be mathematically described by the following equation:

$${P}_{1} ( t ) = \{ \begin{matrix}- 1 , 0. s \leq t < 0.7 s \\ + 1 , 0.7 s \leq t < 1.4 s \\ - 1 , 1.4 s \leq t < 2.1 s \\ 0 , otherwise\end{matrix}$$

where a “+1” refers to tone presence, a “−1” refers to tone absence (e.g. because the siren switched to a different frequency) and a “0” refers to areas that are ignored. In the above example, it is assumed that a siren tone of fundamental frequency ω₁ is active for a duration of 0.7 seconds, followed by a leading and trailing tone absence of 0.7 seconds.

FIG. 7 is another example of typical tone duration pattern, as used in step 575, but for detection of an alternating tone pattern that cycles through 2 different frequencies. In this example, a second tone duration pattern that is shifted by one tone length (i.e. 0.7 seconds) is specified. Thus, for this example, the duration pattern can be mathematically described by the following equation:

$${P}_{2} ( t ) = \{ \begin{matrix}- 1 , 0.7 s \leq t < 1.4 s \\ + 1 , 1.4 s \leq t < 2.1 s \\ - 1 , 2.1 s \leq t < 2.8 s \\ 0 , otherwise\end{matrix}$$

This creates an alternating duration pattern for the second siren tone with fundamental frequency ω₂. In this example, the multi-tone model consists of the two tone-duration patterns.

An example algorithm 800 performed by detection unit 210 for detecting tone duration patterns based on integral signal representations as in step 575 is summarized in FIG. 8.

At step 810, detection unit 210 acquires an integral signal representation in time direction over spectral magnitude values or other values that are calculated based on the spectrogram.

At step 820, for each frequency/duration pattern and for each time stretching factor corresponding to a relevant Doppler shift, detection unit 210 calculates the cross-correlation of the tone duration pattern using the integral image representation.

At step 830, detection unit 210 determines presence of duration pattern by post-processing the result of the cross-correlation.

As explained above, the doppler shifted frequencies ωᵢ^{(α)} and duration patterns Pᵢ^{(α)} of these patterns need to be considered for all relevant time stretching factors α. This is achieved by translating the frequencies ωᵢ and patterns Pᵢ as follows:

$${ω}_{i}^{( α )} = \frac{{ω}_{i}}{α} and {P}_{i}^{( α )} ( t ) = {P}_{i} ( \frac{t}{α} ) t ,$$

Let X(t, ω) denote the short-time Fourier transform (STFT) of the microphone input signal x(t), where t denotes time and ω denotes frequency. Furthermore, let \tilde{X}(t, ω) denote the magnitude spectrogram \tilde{X}(t, ω)=|X(t, ω)|. Then a straight-forward detection δ(t, ωᵢ, Pᵢ) of a time duration pattern Pᵢ at frequency ωᵢ can be achieved by first cross-correlating Pᵢ(t) with \tilde{X}(t, ωᵢ), t=0, . . . , ∞ through convolution with Pᵢ(−t), i.e.

\tilde{X}(t, ωᵢ)×Pᵢ(−t)−∫₀^{∞}\tilde{X}(τ, ωᵢ)×Pᵢ(τ−t)dτ,

and then applying a threshold Γ on the result:

$$δ ( t , {ω}_{i} , {P}_{i} ) = \{ \begin{matrix}1 , \tilde{X} ( t , {ω}_{i} ) ⋆ {P}_{i} ( - t ) > Γ \\ 0 , otherwise\end{matrix}$$

The above cross-correlations become prohibitively expensive if they need to be performed for all possible tone frequencies and duration patterns in all Doppler shifted variants. Advantageously an integral signal representation can be used to efficiently detect the duration patterns Pᵢ. For this, the integral signal representation X̅(t) of a signal X(t) is defined as:

X̅(t)=∫₀^{t}X(τ)dτ

In one example implementation, the integral signal representation can be calculated over the magnitude spectrogram \tilde{X}(t, ωᵢ), in direction of t:

X̅(t, ω)=∫₀^{t}\tilde{X}(τ, ω)dτ

With this representation, the cross-correlation of \tilde{X}(τ, ωᵢ) and Pᵢ(t) is easily obtained, as the Pᵢ always consist of segments that assume a value aₖ=−1 or aₖ=+1 on a corresponding time interval t_{k,start}≤t<t_{k,stop}:

$${\int }_{0}^{∞} \tilde{X} ( τ , {ω}_{i} ) \cdot {P}_{i} ( τ - t ) d τ = {\sum }_{k = 1}^{K} {a}_{k} \cdot ( \overline{X} ( t + {t}_{k , stop} , {ω}_{i} ) - \overline{X} ( t + {t}_{k , start} , {ω}_{i} ) )$$

The calculation includes one multiplication and one subtraction for each segment in the duration pattern. The value K denotes the number of segments, i.e. K=3 in the example P₁(t) from above, for which the cross-correlation with \tilde{X}(t, ω₁) is calculated as:

$${\int }_{0}^{∞} \tilde{X} ( t , {ω}_{1} ) \cdot {P}_{1} ( τ - t ) d τ = \{ \begin{matrix}- ( \overline{X} ( t + 0 \text{.7} , {ω}_{1} ) - \overline{X} ( t + 0 \text{.0} , {ω}_{1} ) ) \\ + ( \overline{X} ( t + 1 \text{.4} , {ω}_{1} ) - \overline{X} ( t + 0 \text{.7} , {ω}_{1} ) ) \\ - ( \overline{X} ( t + 2 \text{.1} , {ω}_{1} ) - \overline{X} ( t + 1 \text{.4} , {ω}_{1} ) )\end{matrix}$$

The actual detection of the duration pattern Pᵢ at frequency ωᵢ and time t is eventually determined according to δ(t, ωᵢ, Pᵢ).

In another example implementation, the integral signal representation can be calculated over a local signal detector Λ(t, ω):

\tilde{Λ}(t, ω)=∫₀^{t}Λ(τ, ω)dτ

A simple local signal detector Λ(t, ω) can detect signal presence, i.e. assume a value of one, if the spectral magnitude value \tilde{X}(t, ω) exceeds a specified SNR threshold Γ_{SNR} whereas it can be zero otherwise:

$$Λ ( t , ω ) = \{ \begin{matrix}1 , \tilde{X} ( t , ω ) / \tilde{N} ( t , ω ) > {Γ}_{SNR} \\ 0 , otherwise\end{matrix}$$

where Ñ(t, ω) denotes a noise spectral magnitude estimate at time t and frequency ω.

It is envisioned that a more sophisticated local signal detector can use a tone, peak or harmonics detector based on more complex functions of spectral magnitude values.

It should be apparent that integral signal representations can also be two sided, i.e. the integral signal representation may be calculated as a two-sided integral if this is suitable:

X̅(t)=∫₋ₜ^{t}X(τ)dτ

It should be apparent that the integral signal representations are calculated in time direction and can be calculated for individual frequency bins of the spectrogram, power ratios of values in the spectrogram or more general functions of the spectrogram, such as a local tone detection measure.

The systems and methods described herein can be used in any of the following applications. For example, upon detecting the sound of an emergency vehicle, a safety module (not shown) within the system 100 and executed in part by the computing device 200. This safety module can automatically reduce the volume of an entertainment system within the vehicle when an emergency vehicle and/or emergency siren is detected. Other responses to the detection of an emergency siren and/or vehicle can be displaying a visual indicator, alerting the driver of the vehicle with a light, sign or other alert signifying that an emergency vehicle is approaching. In instances when the vehicle is operating in an autonomous mode, the safety module can both alert the driver to the presence of the emergency vehicle and instruct the vehicle to enter manual drive mode. Entering manual drive mode can include instructing the user to engage the driving wheel and take over control of the operation of the vehicle.

Still other response to detection of an emergency vehicle can include having the safety module instruct the vehicle to pull over or engage in an evasive maneuver to let the emergency vehicle pass. The safety module can also respond to detection of an emergency vehicle by instructing the vehicle to leave more space between the vehicle and the car ahead of the vehicle, or telling the driver of the vehicle to drive less aggressively or more safely.

In some instances, the security module can detect the direction from which the emergency vehicle is approaching the vehicle, and the distance between the vehicle and the emergency vehicle. Determining both the direction and distance can be difficult because various environments, such as cities, have many obstacles (e.g., skyscrapers, walls, buildings) that can prevent an accurate determination of the location and speed of the emergency vehicle. Crowdsourcing emergency vehicle detection information obtained by nearby cars could be done to alleviate the challenges posed by the environment within which a vehicle is traveling.

Vehicles could each obtain emergency vehicle detection information, and then using the strength and direction of the detected sound, as well as information about the location of each car, the actual location of the emergency vehicle relative to each car in a surrounding area could be determined. Other information may be used such as an enumeration of likely routes for the emergency vehicle (e.g., the best route to the closest hospital), or a scan of news feeds to determine a likely destination (e.g., news feeds or twitter could be scanned to determine that there is a fire two streets over).

Knowing the likely route and speed of an emergency vehicle could be used to alter the vehicle's route. In some instances, once an emergency vehicle is identified, the security module could suggest alternative routes to the driver. When the vehicle is operating in an autonomous mode, the security module can direct the vehicle to alter the route when one or more emergency vehicles are detected and other information suggests a possible incident. For example, the security module could use twitter feeds indicating that a car accident occurred the road ahead and couple that information with the emergency vehicle detection to determine an alternate route is needed.

In some instance, the type of emergency vehicle siren can be determined. For example, a siren generated by a medical emergency vehicle can be distinguished from a siren generated by a law enforcement vehicle.

In some examples, different geographic regions (e.g., different countries, different states within a country, different towns or cities, or different continents) are associated with different multi-tone siren types. For examples, a police car siren in the United States may use a different multi-tone siren type than a police car siren in Germany. Similarly, an ambulance siren in the United States may use a different multi-tone siren type than an ambulance in Germany.

As a result, a huge number of multi-tone siren types exist worldwide. Attempting to detect all of these multi-tone siren types in a given acoustic signal is at best computationally wasteful and at worst not computationally possible. In some examples, the detection system described herein is configured to reduce the number of multi-tone siren types that attempts to detect in an acoustic signal based on a geographic location associated with collection of the acoustic signal.

For example, if the acoustic signal is collected in Germany, then that collection location is associated with the acoustic signal (e.g., in metadata). The detection system reads the metadata associated with the acoustic signal and identifies the collection location as Germany. The detection system then accesses a mapping of geographic locations to multi-tone siren types (e.g., stored in a database) to identify a set of multi-tone siren types associated with Germany. The set of multi-tone siren types includes one or more multi-tone siren types that might be encountered in Germany (e.g., a multi-tone siren types for a German fire truck, a multi-tone siren type for a German police car, a multi-tone siren type for a German ambulance, and so on.).

The detection system then attempts to detect multi-tone siren types from the German set of multi-tone siren types. Detection of other siren types that are unlikely to be encountered is not performed, reducing a computational load on the detection system.

In some examples, a geographic location associated with an acoustic signal may be associated with multiple sets of multi-tone siren types. For example, on a border between German and France, both the German and French sets of multi-tone siren types may be used for detection.

In some examples, there is a master set of multi-tone siren types that is always used for detection and that master set of multi-tone siren types is further augmented based on geographic location. For example, some multi-tone siren types may be used universally across the globe—those multi-tone siren types would reside in the master set of multi-tone siren types.

In some examples, a hierarchy of multi-tone siren types exists. For example, North America may have a set of multi-tone siren types that are common across the continent. Then Canada, Mexico, and the United States may each have their own specific sets of multi-tone siren types. States within those countries may have further specific sets of multi-tone siren types, and so on. A geographic location associated with the acoustic signal can be used to “trace a path” through the hierarchy and combine the sets of multi-tone siren types along the path to generate a combined set of multi-tone siren types for the geographic locations. For example, for processing an acoustic signal associated with a geographic location in Boston, Mass., the detection system would determine a union of a set of multi-tone siren types for North America, a set of multi-tone siren types for the United States, a set of multi-tone siren types for Massachusetts, and a set of multi-tone siren types for Boston. That combined set of multi-tone siren types is used for detection.

While the above illustrates exemplary applications that can use emergency vehicle detection information to take an action, it should be appreciated that the safety module can use the emergency vehicle detection information (i.e., the siren detection, etc.) to take an action that improves the safety of the occupants of the vehicle and those in the environment surrounding the vehicle. These actions can include any combination of modifying the operation of the vehicle, alerting the occupants of the vehicle, or recalculating routes.

It should be understood that elements or functions of the present invention as described above can be implemented in the form of control logic using computer software in a modular or integrated manner. Based on the disclosure and teachings provided herein, a person of ordinary skill in the art will know and appreciate other ways and/or methods to implement the present invention using hardware and a combination of hardware and software.

While the present disclosure has been described with reference to one or more exemplary embodiments, it will be understood by those skilled in the art, that various changes can be made, and equivalents can be substituted for elements thereof without departing from the scope of the present disclosure. In addition, many modifications can be made to adapt a particular situation or material to the teachings of the present disclosure without departing from the scope thereof. Therefore, it is intended that the present disclosure will not be limited to the particular embodiments disclosed herein, but that the disclosure will include all aspects falling within the scope of a fair reading of appended claims.

1. A method for detecting presence of a multi-tone siren type in an acoustic signal, the multi-tone siren type being associated with one or more siren patterns, each siren pattern including a plurality of time patterns at corresponding frequencies, the method comprising:
processing a plurality of frequency components of a frequency domain representation of the acoustic signal over time to determine a corresponding plurality of values, the processing including,
determining, for each frequency component of the plurality of frequency components, a value characterizing a presence of a time pattern associated with at least one siren pattern; and
processing the plurality of values according to the plurality of siren patterns to determine a detection result indicating whether the multi-tone siren type is present in the acoustic signal.

2. The method of claim 1 further comprising causing presentation of an indicator to an operator of a vehicle based on the detection result, the indicator alerting the operator to the presence of the multi-tone siren type.

3. The method of claim 2 wherein the indicator includes a visual indicator.

4. The method of claim 2 wherein the indicator includes an audio indicator.

5. The method of claim 2 wherein the indicator includes an indication of the type of multi-tone siren detected.

6. The method of claim 1 further comprising causing a change in an operating mode of a vehicle based on the detection results.

7. The method of claim 6 wherein the change in the operation mode of the vehicle includes a change from an autonomous operating mode to a manual operating mode.

8. The method of claim 6 further comprising causing an audible presentation of instructions to a driver of the vehicle, the audible presentation of instructions including instructions for the driver to engage the vehicle controls for manual operation.

9. The method of claim 1 further comprising causing a vehicle to reduce a speed of travel based on the detection result.

10. The method of claim 1 further comprising causing a vehicle to perform a maneuver based on the detection result.

11. The method of claim 10 wherein the maneuver includes an evasive maneuver.

12. The method of claim 10 wherein the maneuver includes moving the vehicle to a shoulder of a road.

13. The method of claim 10 wherein the maneuver includes causing the vehicle to change a distance between itself and nearby vehicles.

14. The method of claim 13 wherein changing the distance includes increasing the distance.

15. The method of claim 1 further comprising causing an audible presentation of instructions to a driver of the vehicle, the audible presentation of instructions including instructions for to modify their driving behavior.

16. The method of claim 15 wherein the instructions instruct the driver to drive less aggressively or more safely.

17. The method of claim 1 further comprising causing a navigation system to plan a different route based on the detection result.

18. The method of claim 17 further comprising causing a vehicle associated with the navigation system to autonomously follow the different route.

19. The method of claim 18 wherein the different route circumvents a location of the emergency vehicle.

20. The method of claim 17 wherein the different route is provided to a driver of a vehicle for navigating around a location of an emergency vehicle.

21. The method of claim 1 wherein the detection result is indicative of an event.

22. The method of claim 21 wherein the event includes a car accident.

23. The method of claim 1 further comprising selecting the plurality of siren patterns based at least in part on a siren type corresponding to a geographic location associated with the acoustic signal.

24. The method of claim 1 wherein the plurality of siren patterns includes a group of siren patterns representing a variation in time or frequency of the multi-tone siren type.

25. The method of claim 1 wherein the variation is due to one or more of a doppler shift or a variation within a tolerance associated with the multi-tone siren type.

26. The method of claim 1 wherein each time pattern associated with a siren pattern of the plurality of siren patterns includes a pulsatile sequence at a corresponding frequency.

27. A computer readable medium comprising software embodied thereon, execution of the software by a processor causing detection of presence of a multi-tone siren type in an acoustic signal, the multi-tone siren type being associated with one or more siren patterns, each siren pattern including a plurality of time patterns at corresponding frequencies, the detection of the presence of the siren comprising:
processing a plurality of frequency components of a frequency domain representation of the acoustic signal over time to determine a corresponding plurality of values, the processing including,
determining, for each frequency component of the plurality of frequency components, a value characterizing a presence of a time pattern associated with at least one siren pattern; and
processing the plurality of values according to the plurality of siren patterns to determine a detection result indicating whether the multi-tone siren type is present in the acoustic signal.

28. A system for detecting presence of a multi-tone siren type in an acoustic signal, the multi-tone siren type being associated with one or more siren patterns, each siren pattern including a plurality of time patterns at corresponding frequencies, the system comprising:
an acoustic signal processing module configured to process a plurality of frequency components of a frequency domain representation of the acoustic signal over time to determine a corresponding plurality of values, the processing including,
determining, for each frequency component of the plurality of frequency components, a value characterizing a presence of a time pattern associated with at least one siren pattern; and
a multi-tone siren type detection module configured to process the plurality of values according to the plurality of siren patterns to determine a detection result indicating whether the multi-tone siren type is present in the acoustic signal.
